(19) United States
(12) Patent Application Publication
(10) Pub. No.: US 2016/0292258 A1
(43) Pub. Date: Oct. 6, 2016

(54) METHOD AND APPARATUS FOR FILTERING OUT LOW-FREQUENCY CLICK, COMPUTER PROGRAM, AND COMPUTER READABLE MEDIUM

(71) Applicant: BEIJING QIHOO TECHNOLOGY COMPANY LIMITED, Beijing (CN)

(72) Inventor: Song YANG, Beijing (CN)

(21) Appl. No.: 15/038,442

(22) PCT Filed: Nov. 5, 2014
(86) PCT No.: PCT/CN2014/090384

§ 371 Date: May 20, 2016

(30) Foreign Application Priority Data
Nov. 22, 2013 (CN) 201310597954.0

(51) Int. Cl. G06F 17/30

(52) U.S. Cl. CPC G06F 17/30598; G06F 17/30867

(57) ABSTRACT

There is disclosed a method and an apparatus for filtering out a low-frequency click including: performing feature retrieval on the click data based on click data of a click user to obtain one or more click feature sets of the click user; performing vectorization on the one or more click feature set to obtain one or more click feature vectors of the click user; performing cluster processing on the one or more click feature vectors to obtain a low-frequency click vector set of the click user; and determining a corresponding click is a low-frequency click of the click user according to the low-frequency click vector set, and filtering out the low-frequency click from the click data. By means of the technical solution of the disclosure, a low-frequency click can be filtered out from click data, and filtering precision in a process of filtering out a low-frequency click can be improved.

### CROSS-REFERENCE TO RELATED APPLICATIONS

This application is the national stage of International Application No. PCT/CN2014/090384 filed Nov. 5, 2014 which is based upon and claims priority to Chinese Patent Application No. CN201310597954.0, filed Nov. 22, 2013, the entire contents of all of which are incorporated herein by reference.

### FIELD OF TECHNOLOGY

The disclosure relates to the field of Internet technology and, more particularly, to a method for filtering out low-frequency click, an apparatus for filtering out low-frequency click, a computer program and a computer readable medium.

### BACKGROUND

Low-frequency click refers to an attacking way that malicious users having attack intention performs a small amount of click (such as once or twice) on certain content items or certain fixed content distribution user or certain content of fixed key words, in order to consume the content item display of the users. The attacking mode of the low-frequency click is secluded, may bring losses to the content item distribution user, and may affect the user experience of the content item distribution user. As a result, filtering the low-frequency click to the click data is needed.

In order to effectively find and filter the low-frequency click, the disclosure discloses technical solutions to filter out low-frequency click.

### SUMMARY

In the view of above problems, the disclosure is proposed to provide a method for filtering out low-frequency click, an apparatus for filtering out low-frequency click, a computer program and a computer readable medium.

According to an aspect of the disclosure, there is provided a method for filtering out a low-frequency click comprising:

extracting feature from click data based on the click data of a click user to obtain one or more click feature sets of the click user;

performing vectorization on the click feature sets to obtain one or more click feature vectors of the click user;

performing cluster processing on the click feature vectors to obtain a low-frequency click vector set of the click user; and

determining a corresponding click is a low-frequency click of the click user according to the low-frequency click vector set, and filtering out the low-frequency click from the click data.

According to another aspect of the disclosure, there is provided an apparatus for filtering out a low-frequency click comprising:

a feature extracting module, configured to extract feature from click data based on the click data of a click user to obtain one or more click feature sets of the click user;

a vectorization module, configured to perform vectorization on the click feature sets to obtain one or more click feature vectors of the click user;

a cluster processing module, configured to perform cluster processing on the click feature vectors to obtain a low-frequency click vector set of the click user; and

a filter module, configured to determine a corresponding click is a low-frequency click of the click user according to the low-frequency click vector set, and filter out the low-frequency click from the click data.

According to still another aspect of the disclosure, there is provided computer program, comprising computer readable codes, wherein when the computer readable codes are carried out on a server, the server executes the method for filtering out a low-frequency click above.

According to still another aspect of the disclosure, there is provided a computer readable medium, having stored computer program above.

The beneficial effect of the disclosure is:

According to the technical solution of the disclosure, it is capable to filter out the low-frequency click in the click data, and it has high accuracy compared with the conventional technical solution of filtering low-frequency click.

According to the technical solution of the disclosure, normal click may be ensured not to be filtered out to some extent.

Described above is merely an overview of the inventive scheme. In order to more apparently understand the technical means of the disclosure to implement in accordance with the contents of specification, and to more readily understand above and other objectives, features and advantages of the disclosure, specific embodiments of the disclosure are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the invention. Further, throughout the drawings, same elements are indicated by same reference numbers. In the drawings:

FIG 1 schematically shows a flow chart of the method for filtering low-frequency click according to an embodiment of the disclosure;

FIG 2 schematically shows a flow chart of step S120 according to FIG 1 of an embodiment of the disclosure;

FIG 3 schematically shows a flow chart of step S130 according to FIG 1 of an embodiment of the disclosure;

FIG 4 schematically shows a structural diagram of an apparatus for filtering out low-frequency click according to an embodiment of the disclosure;

FIG 5 is a block diagram schematically illustrating a server for executing the method according the disclosure; and

FIG 6 is a schematically diagram showing a memory unit which is used to store and carry program codes for realizing the method according to the disclosure.

### DESCRIPTION OF THE EMBODIMENTS

Exemplary embodiments of the present disclosure will be described in detail with reference to the accompanying FIGS. hereinafter.

The implementing way of filtering the low-frequency click attack includes: (1) observing click behavior manually, which needs a lot of manpower, the filtering accuracy mainly depends on the observation ability and serious of the observer, and the recall rate is low; (2) filtering according to the complaint of a clicked user (the user distributing the content items), the method is lagging and also has inaccurate factors; (3) filtering based on rules, that is, the click conforms to certain condition is defined as low-frequency click mandatorily and is filtered out. The way based on rules is commonly-used low-frequency click filtering method, but the rule is sometimes too simple, the accuracy is low and is likely to filter many normal clicks mistakenly. In addition, making rules needs to do statistics and analysis deeply to the cheated data.

The improved technical solution of the disclosure is illustrated with reference to the related drawings.

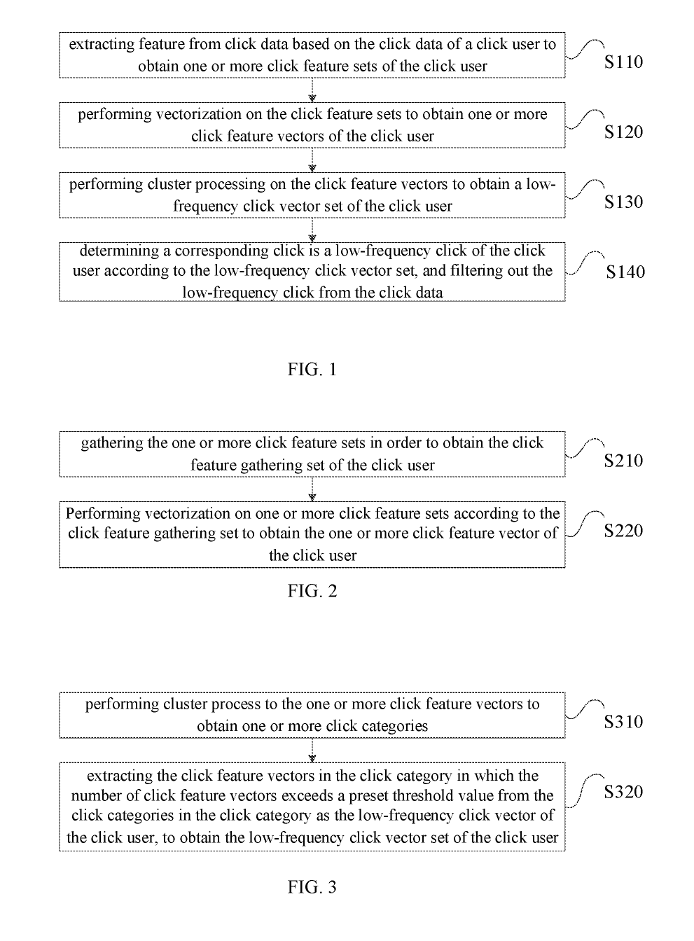

As shown in FIG. 1, it is a flow chart showing the method for filtering low-frequency click according to an embodiment of the disclosure.

In step S110, feature from click data is extracted based on the click data of a click user, to obtain one or more click feature sets of the click user.

Wherein the click data may include the following one or more items: a user identification of the click user, an identification of clicked content item, a search term searched by the click user, a clicked key word, a user identification of a clicked user.

It should be noted that, the meaning of term “click” in the disclosure is not limited to be the click behavior to the content item performed by the user, it also includes searching behavior, which may be, for example, searching by inputting search term.

Wherein the user identification of the click user is the identification representing the identity of the click user (the user clicking or searching the content item), for example, the identification of Cookie (data stored in the local user terminal by the website in order to identify the user identity) of the click user may be used to identify the identity of the click user, e.g. the Cookie ID. The identification of clicked content item is the identification used for identify the clicked content item. The search term searched by the click user is the search term used by the click user when he or she searches. The clicked key word is the key word of the clicked content item, the distribution user of the content item obtains the relation right (divided by priority) of the key word of the content item distributed by the user. When the user inputs information similar with the key word, the content item may be displayed to the user according to the priority of the relation right of the key word of the distribution user of the content item. The user identification of the clicked user is the identification which represents the identity of the distribution user of the clicked content item.

When extracting feature to the click data of the click user, the extracted feature may include one or more items of: a content item identification feature, a search term feature, a key word feature, a user identification feature of the clicked user.

It should be noted that, in the disclosure, the click user is the click user that takes the user identification of the click user to identify the user identity, extracting feature from the click data of the click user and the subsequent operations such as vectorization, cluster processing all take the user identification of the click user identify a specific click user.

Extracting feature in the click data of the click user to obtain one or more click feature sets of the click user may be specifically described as below: firstly the click data of the click user may be divided into one or more click data sets according to certain attribute (for example, the click data are divided by each day according to date attribute, that is the data in N days are divided into N click data sets, everyday click data is a click data set), then extracting feature from the click data in every click data set to obtain one or more click feature sets corresponding to the one or more click data sets; it is also capable to extract feature from the click data and then divide the extracted features into one or more click feature sets according to certain rule.

It should be noted that, there may be more than one features of a certain attribute included in the click feature set obtained after extracting feature from the click data of the click user, for example, the content item identification feature extracted from the click data of the click user may include SIF_123 and SIF_234 (SIF represents content item identification feature).

It should be noted that, the invention is not limited herein. Instead, other proper methods may also be used to extract feature from the click data of the click user to obtain the one or more click feature sets of the click user.

According to an embodiment of the disclosure, when extracting feature from the click data of the click user, it is also capable to extract feature of everyday click data of the user to obtain the click feature set corresponding to the one or more everyday click data of the click user. That is, the feature is extracted from the click data of the click user in the unit of per day. That is, the click data of the click user in each day corresponds to a click feature set. For example, if the obtained click data is N days' click data (N≧1), after feature extraction, N click feature sets may be obtained.

For example, after extracting feature in 5 days' click data of the click user C, the click feature sets corresponding to click data in each day are:

Features_{C,1}={SIF_123, SIF_234, SKF_mobile phone, SKF_MP3, BF_mobile phone, BF_color screen MP3, MF_member1, MF_member2};

Features_{C,2}={SIF_123, SIF_345, SKF_smart mobile phone, SKF₋MP3, BF_mobile phone, BF_color screen MP3, MF_member1, MF_member3};

Features_{C,3}={SIF_123, SIF_345, SKF_mobile phone, SKF_MP3, BF_smart mobile phone, BF_color screen MP3, MF_member2, MF_member3};

Features_{C,4}={SIF_234, SIF_345, SKF_MP3, SKF_smart mobile phone, BF_mobile phone, BF_MP3, MF_member1, MF_member3};

Features_{C,5}={SIF_123, SIF_234, SKF_mobile phone, SKF_MP3, BF_smart mobile phone, BF_MP3, MF_member1, MF_member2}

Wherein the click feature set is represented by Features_{C,i}, C represents the user identification of the click user, I represents the i^{th} day, that is Features_{C,i} represents the click feature set of the user C on the i^{th} day. SIF represents the content item identification feature, SKF represents the search term feature, BF represents key word feature, MF represents user identification feature of the clicked user.

In step S120, vectorization is performed on the click feature sets to obtain one or more click feature vectors of the click user. That is, each of the obtained click feature sets is vectorized to obtain the click feature vector corresponding to each click feature set.

As shown in FIG. 2, it is a flow chart showing step S120 according to FIG 1 of an embodiment of the disclosure.

Vectorization to the one or more click feature sets may be performed in the following step.

In step S210, gathering the one or more click feature sets in order to obtain the click feature gathering set of the click user. Specifically, the one or more click feature sets may be combined, the repeated feature in the combined set is removed to obtain the click feature gathering set of the click user. That is, firstly the one or more obtained click feature sets is combined to be one set, and then the repeated features in the combined set is removed to obtain the click feature gathering set in the click user.

For example, in the example in step S110, the click feature sets of the user C, which are Features_{C,1}, Features_{C,2}, Features_{C,3}, Features _{C,4}Features_{C,5} are combined, then the set M is obtained:

M={SIF_123, SIF_234, SKF_mobile phone, SKF_MP3, BF_mobile phone, BF_color screen MP3, MF_member1, MF_member2, SIF_123, SIF_345, SKF_smart mobile phone, SKF_MP3, BF_mobile phone, BF_color screen MP3, MF_member1, MF_member3, SIF_123, SIF_345, SKF_mobile phone, SKF_MP3, BF_smart mobile phone, BF_color screen MP3, MF_member2, MF_member3, SIF_234, SIF_345, SKF_MP3, SKF_smart mobile phone, BF_mobile phone, BF_MP3, MF_member1, MF_member3, SIF_123, SIF_234, SKF_mobile phone, SKF_MP3, BF_smart mobile phone, BF_MP3, MF_member1, MF_member2}.

Removing the repeated features in the set M may obtain the click feature gathering set Dimesionality_{C} of the click user C:

Dimesionality_{C}={SIF_123, SIF_234, SKF_mobile phone, SKF_MP3, BF_mobile phone, BF_color screen MP3, MF_member1, MF_member2, SIF_345, SKF_smart mobile phone, MF_member3, BF_smart mobile phone, BF_MP3}.

In step S220, the one or more click feature sets are vectorized according to the click feature gathering set to obtain the one or more click feature vectors of the click user.

According to an embodiment of the disclosure, it is capable to compare the features in the click feature gathering set with the feature in the one or more click feature set to obtain one or more click feature vectors corresponding to the one or more click feature sets.

Specifically, to a click feature set, it is capable to compare all the features in the click feature gathering set with the features in the click feature set to obtain a click feature vector of the click feature set whose each vector component corresponds to each feature in the click feature gathering set in turn. In the click feature vector, corresponding to the feature in the click feature gathering set, the vector component corresponding to the feature appearing in the click feature set is 1, the vector component corresponding to the feature not appearing in the click feature set is 0.

For example, the click feature set of the user C on the first day is Features_{C,1}={SIF_123, SIF_234, SKF_mobile phone, SKF_MP3, BF_mobile phone, BF_color screen MP3, MF_member1, MF_member2}; click feature gathering set of the user C Dimesionality_{C}={SIF_123, SIF_234, SKF_mobile phone, SKF_MP3, BF_mobile phone, BF_color screen MP3, MF_member1, MF_member2, SIF_345, SKF_smart mobile phone, MF_member3, BF_smart mobile phone, BF_MP3}, using Vector_{C,i} to represent the click feature vector of the user C on the i^{th} day, then all the features in the click feature gathering set are compared with the features in the click feature set in turn, Vector_{C,1}={1,1,1,1,1,1,1,1,0,0,0,0,0,} is obtained. Wherein the click feature gathering set has thirteen features, and each click feature vector has 13 vector components correspondingly.

That is, according to whether the feature in the click feature gathering set appears in the click feature set, the one or more click feature sets are vectorized, after performing vectorization on each click feature set, each vector component of the obtained click feature vector one-to-one corresponds to each feature in the click feature gathering set in turn. Therefore, the number of vector components of the click feature vector equals to the number of features in the click feature gathering set. That is, if the click feature gathering set has m characteristics, after performing vectorization to the one or more click feature sets, the obtained one or more click feature vectors are m-dimensional vectors.

The click feature sets of the user C in five days in the above example are vectorized, then five click feature vectors of the user C may be obtained, they are:

vector_{C,1}={1,1,1,1,1,1,1,1,0,0,0,0,0};

vector_{C,2}={1,0,0,1,1,1,1,0,1,1,1,0,0};

vector_{C,3}={1,0,1,1,0,1,0,1,1,0,1,0,0};

vector_{C,4}={0,1,0,1,1,0,1,0,1,1,1,0,1,};

vector_{C,5}={1,1,1,1,,0,0,1,1,0,0,0,1,1}.

It should be noted that, the invention is not limited thereto, it is also capable to user other proper methods to perform vectorization on the one or more click feature sets.

In step S130, performing cluster processing to the one or more click feature vectors to obtain the low-frequency click vector set of the click user.

As shown in FIG. 3, it is a flow chart of step S130 according to FIG 1 of an embodiment of the disclosure. Step S130 may further include steps S310 to S320.

In step S310, performing cluster process to the one or more click feature vectors to obtain one or more click categories, wherein each of the one or more click categories at least include a click feature vector.

Performing cluster process to the one or more click feature vectors is to cluster the one or more click feature vectors to be one or more vector sets according to similarity, which is the click categories. Wherein each click category at least includes a click feature vector. According to the embodiment of the disclosure, a clustering algorithm may be used to calculate the similarity of the one or more click feature vectors first, and then the one or more click feature vectors are clustered to be one or more click categories according to the result of similarity calculation. For example, a k-Nearest Neighbor (KNN) algorithm may be used to perform clustering process.

In step S320, extracting the click feature vectors in the click category in which the number of click feature vectors exceeds a preset threshold value from the click categories in the click category as the low-frequency click vector of the click user, to obtain the low-frequency click vector set of the click user. Wherein the preset threshold value may be determined according to analyzing the history data. For example, it may be determined by analyzing complaint data of large amount of users (the user distributing the content item).

For example if the preset threshold value is ξ=2, the m click categories obtained after cluster are C₁, C₂, C₃ . . . Cₘ. The number of click feature vectors in the click category Cⱼ is three, the number of click feature vector in the click category Cₖ are four, the number of the click feature vectors in the Cⱼ, and Cₖ exceeds the preset threshold value ξ then the total seven click feature vectors in the click categories Cⱼ, and Cₖ are used as the low-frequency click vector of the click user, and the seven low-frequency click vectors are gathered to be one vector set, that is the low-frequency click vector set of the click user.

In step S140, it is determined the corresponding click is the low-frequency click of the click user according to the low-frequency click vector set, and then the low-frequency click is filtered out from the click data. That is, to the low-frequency click vector in the low-frequency click vector set, it is capable to find the click corresponding to each low-frequency click, which is the low-frequency click of the user.

For example, it is capable to obtain the click corresponding to each click vector according to the click feature gathering set of the click user in step S210. Each vector component of the click feature vector obtained by performing vectorization on each click feature set one-to-one corresponds to the features of the click feature gathering set in turn, therefore it is capable to find the corresponding clicking features according to their corresponding relation.

According to an embodiment of the disclosure, the step as follow may be further include: extracting the feature of the click corresponding to the low-frequency click vector set of the click user to generate the low-frequency click filter table corresponding to the click user.

Specifically, it is capable to gather each feature of the corresponding click after finding the corresponding clicking of each low-frequency click vector in the low-frequency click vector set of the click user, for example, the content item identification feature, the search term feature, the key word feature, the user identification feature of the clicked user and so on, and then the low-frequency click filter table corresponding to the click user is generated. Wherein the low-frequency click filter table is used to filter out the click related to the feature included in the low-frequency click filter table performed by the click user. That is, it is capable to filter out the click corresponding to the feature in the table performed by the click user according to the low-frequency click filter table. By using the low-frequency click filter table to perform filtering, it is ensured in some extent that normal click is not filtered.

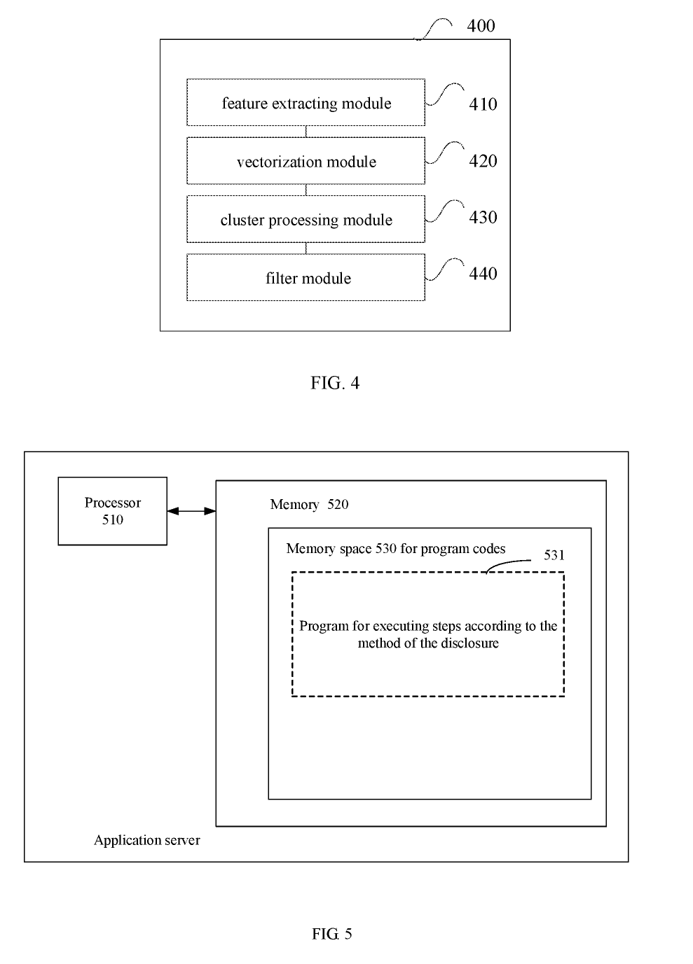

The disclosure further discloses an apparatus for filtering out low-frequency click. As shown in FIG 4, it is a structural diagram of an apparatus 400 for filtering out low-frequency click according to an embodiment of the disclosure. The apparatus includes: a feature extracting module 410, a vectorization module 420, a cluster processing module 430 and a filter module 440.

The feature extracting module 410 may be configured to extract feature from click data based on the click data of a click user to obtain one or more click feature sets of the click user.

The vectorization module 420 may be configured to perform vectorization on the click feature sets to obtain one or more click feature vectors of the click user.

The cluster processing module 430 may be configured to perform cluster processing on the click feature vectors to obtain a low-frequency click vector set of the click user.

The filter module 440 may be configured to determine a corresponding click is a low-frequency click of the click user according to the low-frequency click vector set, and filter out the low-frequency click from the click data.

The click data may include one or more items of: a user identification of the click user, an identification of clicked content item, a search term searched by the click user, a clicked key word, a user identification of a clicked user.

When extracting feature from the click data of the click user, the extracted feature comprises one or more items of: a content item identification feature, a search term feature, a key word feature, a user identification feature of the clicked user.

According to an embodiment of the disclosure, the feature extracting module 410 may be further configured to: extract feature from everyday click data of the click user to obtain one or more click feature sets corresponding to the everyday click data of the click user.

According to an embodiment of the disclosure, the vectorization module 420 may include a gathering sub-module and a vectorization sub-module. The gathering sub-module may be configured to gather the click feature sets to obtain a click feature gathering set of the click user; the vectorization sub-module may be configured to perform vectorization on the click feature sets to obtain one or more click feature vectors of the click user according to the click feature gathering set.

According to an embodiment of the disclosure, the gathering sub-module may be further configured to gather the click feature sets, removing repeated feature in the gathered set to obtain the click feature gathering set of the click user.

According to an embodiment of the disclosure, the vectorization sub-module may be further configured to compare the feature in the click feature gathering set with the feature in the click feature sets to obtain one or more click feature vectors corresponding to the click feature sets.

According to an embodiment of the disclosure, the cluster processing module 430 may include a cluster processing sub-module and an extracting sub-module. The cluster processing sub-module may be configured to perform cluster processing on the click feature vectors to obtain one or more click categories; wherein each of the click categories at least comprises a click feature vector. The extracting sub-module may be configured to extracting the click feature vectors in the click category in which the number of click feature vectors exceeds a preset threshold value from the click categories as a low-frequency click vector of the click user to obtain the low-frequency click vector set.

According to an embodiment of the disclosure, the apparatus may further includes a filter table generating module, the module may be configured to extract the click feature corresponding to the low-frequency click vector set of the click user to generate a low-frequency click filter table corresponding to the click user, wherein the low-frequency click filter table is used to filter out the click related to the feature included in the low-frequency click filter table performed by the click user.

The apparatus for filtering out low-frequency click described above corresponds to the method for filtering out low-frequency click described previously. Therefore, the detailed technical detail may be referred to the method described previously.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the apparatus for filtering out low-frequency click according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

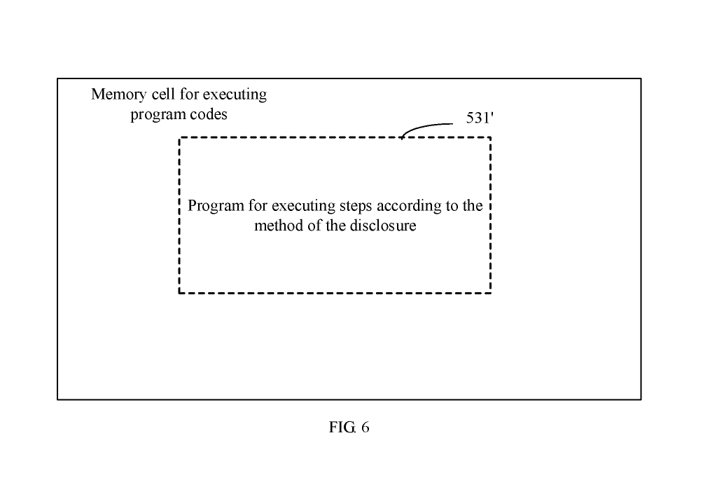

For example, FIG. 5 illustrates a block diagram of a server for executing the method for filtering out low-frequency click according the disclosure, the server may be an application server. Traditionally, the server includes a processor 510 and a computer program product or a computer readable medium in form of a memory 520. The memory 520 could be electronic memories such as flash memory, EEPROM (Electrically Erasable Programmable Read—Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG 6. The memory cells may be provided with memory sections, memory spaces, etc., similar to the memory 520 of the server as shown in FIG. 5. The program codes may be compressed for example in an appropriate form. Usually, the memory cell includes computer readable codes 531′ which can be read for example by processors 510. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

1. A method for filtering out a low-frequency click comprising:
extracting feature from click data based on the click data of a click user to obtain one or more click feature sets of the click user;
performing vectorization on the click feature sets to obtain one or more click feature vectors of the click user;
performing cluster processing on the click feature vectors to obtain a low-frequency click vector set of the click user; and
determining a corresponding click is a low-frequency click of the click user according to the low-frequency click vector set, and filtering out the low-frequency click from the click data.

2. The method according to claim 1, wherein the click data comprises one or more items of: a user identification of the click user, an identification of a clicked content item, a search term searched by the click user, a clicked key word, a user identification of a clicked user.

3. The method according to claim 1, wherein when extracting feature from the click data of the click user, the extracted feature comprises one or more items of: a content item identification feature, a search term feature, a key word feature, a user identification feature of the clicked user.

4. The method according to claim 1, wherein the extracting feature from the click data to obtain one or more click feature sets of the click user further comprises:
extracting feature from everyday click data of the click user to obtain one or more click feature sets corresponding to the everyday click data of the click user.

5. The method according to claim 1, wherein the performing vectorization on the click feature sets to obtain one or more click feature vectors of the click user comprises:
gathering the click feature sets to obtain a click feature gathering set of the click user;
performing vectorization on the click feature sets to obtain one or more click feature vectors of the click user according to the click feature gathering set.

6. The method according to claim 5, wherein the gathering the click feature sets to obtain a click feature gathering set of the click user further comprises:
gathering the click feature sets, removing repeated feature in the gathered set to obtain the click feature gathering set of the click user.

7. The method according to claim 5 wherein the performing vectorization on the click feature sets to obtain one or more click feature vectors of the click user according to the click feature gathering set further comprises:
comparing the feature in the click feature gathering set with the feature in the click feature sets to obtain one or more click feature vectors corresponding to the click feature sets.

8. The method according to claim 1, wherein the performing cluster processing on the click feature vectors to obtain a low-frequency click vector set of the click user comprises:
performing cluster processing on the click feature vectors to obtain one or more click categories; wherein each of the click categories at least comprises a click feature vector;
extracting the click feature vectors in the click category in which the number of click feature vectors exceeds a preset threshold value from the click categories as a low-frequency click vector of the click user to obtain the low-frequency click vector set of the click user.

9. The method according to claim 1, further comprising:
extracting the feature of click corresponding to the low-frequency click vector set of the click user to generate a low-frequency click filter table corresponding to the click user, wherein the low-frequency click filter table is used to filter out the click related to the feature included in the low-frequency click filter table performed by the click user.

10. A server for filtering out a low-frequency click comprising:
a memory having instructions stored thereon,
a processor configured to execute the instructions to perform operations for performing filtering out a low-frequency click, comprising:
extracting feature from click data based on the click data of a click user to obtain one or more click feature sets of the click user;
performing vectorization on the click feature sets to obtain one or more click feature vectors of the click user;
performing cluster processing on the click feature vectors to obtain a low-frequency click vector set of the click user; and
determining a corresponding click is a low-frequency click of the click user according to the low-frequency click vector set, and filtering out the low-frequency click from the click data.

11. The server according to claim 10, wherein the click data comprises one or more items of: a user identification of the click user, an identification of clicked content item, a search term searched by the click user, a clicked key word, a user identification of a clicked user.

12. The server according to claim 10, wherein when extracting feature from the click data of the click user, the extracted feature comprises one or more items of: a content item identification feature, a search term feature, a key word feature, a user identification feature of the clicked user.

13. The server according to claim 10, wherein the extracting feature from the click data to obtain one or more click feature sets of the click user further comprising:
extracting feature from everyday click data of the click user to obtain one or more click feature sets corresponding to the everyday click data of the click user.

14. The server according to claim 10, wherein the performing vectorization on the click feature sets to obtain one or more click feature vectors of the click users comprises:
gathering the click feature sets to obtain a click feature gathering set of the click user;
a performing vectorization on the click feature sets to obtain one or more click feature vectors of the click user according to the click feature gathering set.

15. The server according to claim 14, wherein the gathering the click feature sets to obtain a click feature gathering set of the click user further comprises:
gathering the click feature sets, removing repeated feature in the gathered set to obtain the click feature gathering set of the click user.

16. The server according to claim 14, wherein the performing vectorization on the click feature sets to obtain one or more click feature vectors of the click user according to the click feature gathering set further comprises:
comparing the feature in the click feature gathering set with the feature in the click feature sets to obtain one or more click feature vectors corresponding to the click feature sets.

17. The server according to claim 10, wherein the performing cluster processing on the click feature vectors to obtain a low-frequency click vector set of the click user comprises:
performing cluster processing on the click feature vectors to obtain one or more click categories; wherein each of the click categories at least comprises a click feature vector;
the click feature vectors in the click category in which the number of click feature vectors exceeds a preset threshold value from the click categories as a low-frequency click vector of the click user to obtain the low-frequency click vector set of the click user.

18. The server according to claim 10, wherein the processor is further configured to perform:
extracting the feature of click corresponding to the low-frequency click vector set of the click user to generate a low-frequency click filter table corresponding to the click user, wherein the low-frequency click filter table is used to filter out the click related to the feature included in the low-frequency click filter table performed by the click user.

19. (canceled)

20. A non-transitory computer readable medium, having computer programs stored thereon that, when executed by one or more processors of a server, cause the server to perform:
extracting feature from click data based on the click data of a click user to obtain one or more click feature sets of the click user;
performing vectorization on the click feature sets to obtain one or more click feature vectors of the click user;
performing cluster processing on the click feature vectors to obtain a low-frequency click vector set of the click user; and
determining a corresponding click is a. low-frequency click of the click user according to the low-frequency click vector set, and filtering out the low-frequency click from the click data.
